(19) United States
(12) Patent Application Publication
(10) Pub. No.: US 2004/0172651 A1
(43) Pub. Date: Sep. 2, 2004

(54) Short term surfing channel list

(76) Inventors: Anthony J. Wasilewski, Alpharetta, GA (US); Luis A. Rovira, Atlanta, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/376,863

(22) Filed: Feb. 28, 2003

(51) Int. Cl. G06F 3/00; H04N 5/445; G06F 13/00

(52) U.S. Cl. 725/46; 725/56

(57) ABSTRACT

A system for recalling surfed channels includes functionality that stores identifications of surfed channels and recalls each of the surfed channels in response to a user pressing a button on a device.

### TECHNICAL FIELD

The present invention is generally related to television systems, and, more particularly, is related to interactive television systems.

### BACKGROUND OF THE INVENTION

With recent advances in digital transmission technology, subscriber television systems are now capable of providing much more than the traditional analog broadcast video. In implementing enhanced programming, the home communication terminal device (“HCT”), otherwise known as the set-top box, has become an important computing device for accessing content services (and content within those services) and navigating a user through a maze of available services. In addition to supporting traditional analog broadcast video functionality, digital HCTs (or “DHCTs”) now also support an increasing number of two-way digital services such as video-on-demand and personal video recording.

Typically, a DHCT is connected to a cable or satellite, or generally, a subscriber television system, and includes hardware and software necessary to provide the functionality of the digital television system at the user's site. Some of the software executed by a DHCT can be downloaded and/or updated via the subscriber television system. Each DHCT also typically includes a processor, communication components, and memory, and is connected to a television or other display device, such as a personal computer. While many conventional DHCTs are stand-alone devices that are externally connected to a television set, a DHCT and/or its functionality may be integrated into a television set or personal computer or even an audio device such as a programmable radio, as will be appreciated by those of ordinary skill in the art.

DHCTs are typically capable of providing users with a very large number and variety of content choices. With the large array of choices, subscribers have a difficult time keeping track of the channels they have accessed. Thus, a heretofore unaddressed need exists in the industry to address the aforementioned and/or other deficiencies and/or inadequacies.

### BRIEF DESCRIPTION OF THE DRAWINGS

The preferred embodiments of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram depicting a non-limiting example of a subscriber television system (STS), in accordance with one embodiment of the invention.

FIG. 2 is a block diagram depicting a non-limiting example of selected components of a headend as depicted in FIG. 1, in accordance with one embodiment of the invention.

FIG. 3 is a block diagram depicting a non-limiting example of selected components of a DHCT as depicted in FIG. 1, which is coupled to a headend and to a television set, in accordance with one embodiment of the invention.

FIG. 4 is a schematic diagram of one example remote control device to provide input to the DHCT 16 illustrated in FIG. 3, in accordance with one embodiment of the invention.

FIG. 5 is a schematic diagram depicting a non-limiting example of select components of the example remote control device illustrated in FIG. 4, in accordance with one embodiment of the invention.

FIG. 6A is a screen diagram of an example user settings screen, in accordance with one embodiment of the invention.

FIG. 6B is a screen diagram of an example Last channel user configuration screen for configuring Last channel functionality, in accordance with one embodiment of the invention.

FIGS. 7A-7D are screen diagrams of example presentation screens that a user surfs through, in accordance with one embodiment of the invention.

FIGS. 8A-8C are composite diagrams that illustrate how a user can use a Last channel button to scroll through the surfed channels illustrated in FIGS. 7B-7D, in accordance with one embodiment of the invention.

FIGS. 9A-9C are composite diagrams illustrating how a user can use a Last channel button to scroll through the surfed channels illustrated in FIGS. 7B-7D in an interactive program guide, in accordance with one embodiment of the invention.

### DETAILED DESCRIPTION, OF THE PREFERRED EMBODIMENTS

The preferred embodiments of the invention now will be described more fully hereinafter with reference to the accompanying drawings, in which preferred embodiments of the invention are shown. The preferred embodiments of the invention will herein be described in the context of a subscriber television system, with the understanding that other communication systems can similarly benefit, including home entertainment systems, among others. In particular, the preferred embodiments of the invention include a system and method for recalling surfed channels. Herein, recalling or recalled or the like will be understood to include, among others, automatically tuning to a display channel corresponding to a live or time-shifted broadcast, and/or highlighting a program entry in an IPG screen or browser banner (or other similarly structured screens) corresponding to prior-tuned display channel. Herein, surfed channels will be understood to include, among others, channels to which the user has tuned to, or otherwise selected, during an arbitrary time period to invoke a real-time (or time shifted) presentation of a content instance (e.g., program episode, movie, etc.). Channels can be surfed according to any well-known mechanisms, such as entering a channel number, using a channel up/down button, a page up/down button, a favorites button, among others. In one embodiment of the invention, the user can recall surfed channels up to a user-configured quantity by pressing the Last channel button on a remote control device. For each Last channel keypress, surfed channels are recalled, preferably in reverse order to the order of surfing the channels. The user can also scroll through surfed channels in accordance with the preferred embodiments of the invention while in an interactive program guide (IPG), such as by selecting the Last channel button, as one example.

Since the preferred embodiments of the invention are described in the context of a subscriber television system, a subscriber television system is described, followed by descriptions of headend and DHCT components of the system. Following the description of these components, an example remote control devices is described, including a detailed schematic of the internal processing of the example remote control device. As described above, implementations of the Last channel can occur through an IPG screen and real-time (or time-shifted) presentation screens, and thus the preferred embodiments will be described in the context of these two implementations.

The preferred embodiments of the invention may, however, be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” given herein are intended to be non-limiting, and are included as examples among many others contemplated and within the scope of the preferred embodiments of the invention.

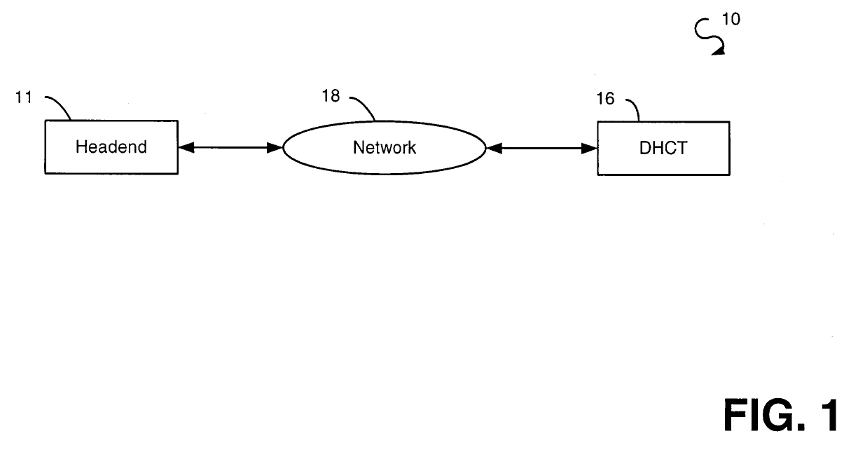

FIG. 1 is a block diagram depicting a non-limiting example of a subscriber television system (STS) 10. In this example, the STS 10 includes a headend 11 and a digital home communication terminal (DHCT) 16 that are coupled via a communications network 18. It will be appreciated that the STS 10 shown in FIG. 1 is merely illustrative and should not be construed as implying any limitations upon the scope of the preferred embodiments of the invention. For example, although single components (e.g., a headend and a DHCT) are illustrated in FIG. 1, the STS 10 can feature a plurality of any one of the illustrated components, or may be configured with alternative embodiments for any one of the individual components or with yet other additional components not enumerated above. Subscriber television systems also included within the scope of the preferred embodiments of the invention include systems not utilizing physical structured cabling for transmission, such as, but not limited to, satellite systems.

A DHCT 16 is typically situated at the residence or place of business of a user and may be a stand-alone unit or integrated into another device such as, for example, a television set or a personal computer or other display devices, or an audio device. The customer's premises may be a user's residence or place of business, among others. The DHCT 16 receives signals (video, audio and/or other data) from the headend 11 through the network 18 and provides reverse information to the headend 11 through the network 18.

The headend 11 receives, among other data and/or content, program guide data from a program guide information provider (not shown). The program guide information (data) preferably comprises data corresponding to services that may be provided via the DHCT 16. The headend 11 edits the program guide data and transmits the edited program guide data to the DHCT 16 via the network 18. The headend 11 may include one or more server devices (not shown) for providing video and/or audio and/or data to media client devices such as the DHCT 16. The headend 11 and the DHCT 16 cooperate to provide a user with television services via the television set (not shown). The television services may include, for example, broadcast television services, cable television services, premium television services, video-on-demand (VOD) services, and/or pay-per-view (PPV) services, among others.

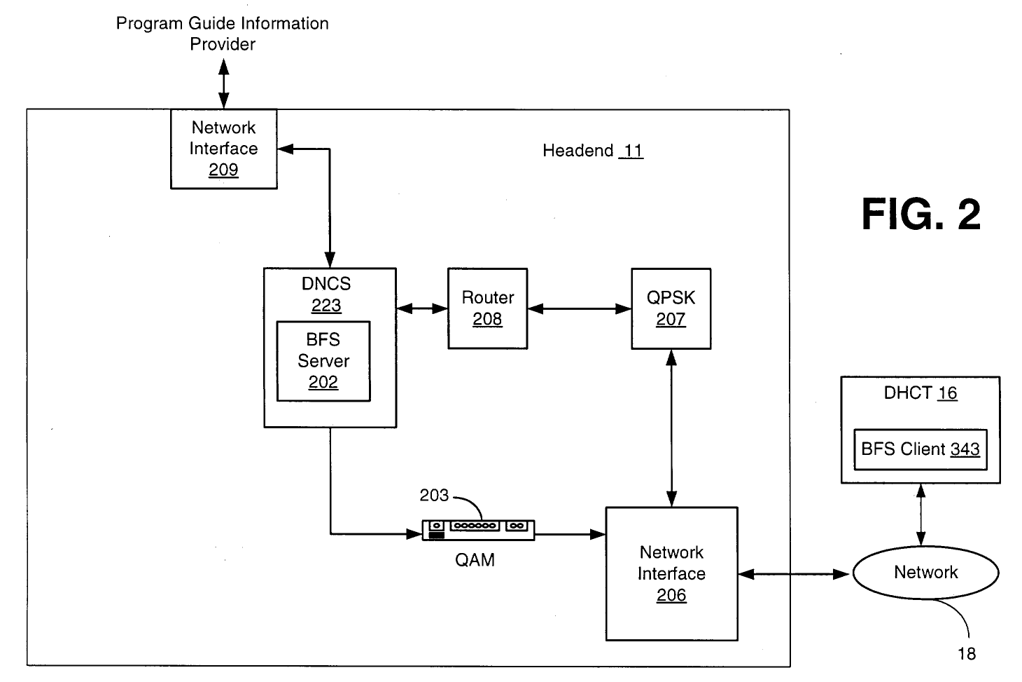

FIG. 2 depicts a non-limiting example of selected components of a headend 11 that is configured in accordance with one embodiment of the present invention. It will be understood that the headend 11 shown in FIG. 2 is merely illustrative and should not be construed as implying any limitations upon the scope of the preferred embodiments of the invention. The headend 11 receives content from a variety of service and content providers, which can provide input in a variety of ways. The headend 11 combines the content from the various sources and distributes the content to subscribers via the distribution systems of the network 18. The input signals may be transmitted from sources to the headend 11 via a variety of transmission paths, including satellites (not shown), and terrestrial broadcast transmitters and antennas (not shown).

A digital network control system (DNCS) 223 provides management, monitoring, and control of the network's elements and of the broadcast services provided to users. A content provider such as a program guide information provider transmits data for television program guides through a network interface 209 to the DNCS 223 of the headend 11, preferably using a file transfer protocol (FTP). The DNCS 223 includes functionality that defines relationships between channel names listed in the program guide data received from the program guide provider and the numbered channels that are available via the DHCT 16. This functionality is used by the DNCS 223 to edit the program guide data to include channel numbers that correspond to the listed channel names. After the program guide data is edited by the DNCS 223, it is transmitted to the DHCT 16 preferably using a broadcast file system (BFS) server 202. The BFS server 202 and its counterpart, a BFS client module 343 in the DHCT 16, are part of a file broadcasting system. The BFS server 202 repeatedly sends data through a network interface 206 to the DHCT 16 via a quadrature amplitude modulation (QAM) modem 203 over a period of time in a cyclical manner so that the DHCT 16 may access the data as needed. Of course other mechanisms and techniques may be utilized to transfer data to the DHCT 16.

A quadrature phase shift keying (QPSK) modem 207 is responsible for transporting out-of-band IP (internet protocol) datagram traffic between the distribution headend 11 and a DHCT 16. Data transmitted or received by the QPSK modem 207 may be routed by a headend router 208. The headend router 208 may be used to deliver upstream data to the various server applications (not shown).

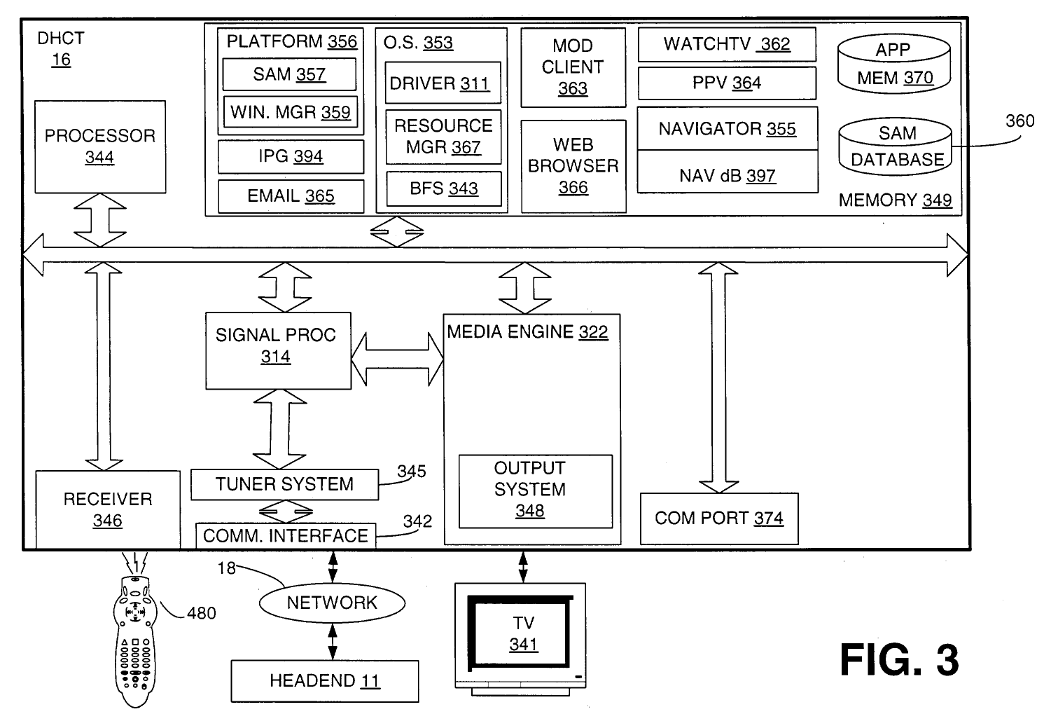

FIG. 3 is a block diagram illustration of an example DHCT 16 that is coupled to a headend 11 and to a television set 341, in accordance with one embodiment of the invention. It will be understood that the DHCT 16 shown in FIG. 3 is merely illustrative and should not be construed as implying any limitations upon the scope of the preferred embodiments of the invention. For example, some of the functionality performed by applications executed in the DHCT 16 (such as an MOD application 363) may instead be performed completely or in part at the headend 11 and vice versa, or not at all in some embodiments. The DHCT 16 preferably includes a communications interface 342 for receiving signals (video, audio and/or other data) from the headend 11 through the network 18 and for providing any reverse information to the headend 11 through the network 18.

The DHCT 16 preferably includes one or more processors, such as processor 344 (e.g., a central processing unit or digital signal processor), for controlling operations of the DHCT 16, an output system 348 for driving the television set display, and a tuner system 345 for tuning into a particular television channel or frequency to display content and for sending and receiving various types of data or content to and from the headend 11. The DHCT 16 may include, in other embodiments, multiple tuners for receiving downloaded (or transmitted) content. The tuner system 345 enables the DHCT 16 to tune to downstream media and data transmissions, thereby allowing a user to receive digital and/or analog content delivered in the downstream transmission via the subscriber television system. The tuner system 345 includes, in one implementation, an out-of-band tuner for bi-directional QPSK data communication and one or more QAM tuners (in band) for receiving television signals. Additionally, a receiver 346 receives externally generated information, such as user inputs or commands from an input device, such as remote control device 480, or other devices.

The DHCT 16 processes analog and/or digital transmission signals for storage in a storage device such as an optical or hard disk drive (not shown), and/or for display to the television set 341. The DHCT 16 preferably includes a signal processing system 314 and a media engine 322. The components of the signal processing system 314 are capable of QAM demodulation, forward error correction, and demultiplexing MPEG-2 transport streams, and parsing elementary streams and packetized elementary streams. Additional components, not shown, include an analog decoder and compression engine for processing an analog transmission signal and, in one implementation, converting it to compressed audio and video streams that are produced in accordance with the syntax and semantics of a designated audio and video coding method, such as specified by the MPEG-2 audio and MPEG-2 video ISO/IEC 13818 standard.

The signal processing system 314 outputs packetized compressed streams and presents them as input for storage in the storage device, or in other implementations, as input to the media engine 322 for decompression by a video decompression engine (not shown) and an audio decompression engine (not shown) for display on the TV set 341. One having ordinary skill in the art will appreciate that the signal processing system 314 will preferably include other components not shown, including memory, decryptors, samplers, digitizers (e.g., analog-to-digital converters), and multiplexers, among other components. Further, it will be understood that one or more of the components listed above will interface with the processor 344 and/or system memory 349 (and/or dedicated memory for a particular component) to facilitate data transfer and/or processing of the video and/or audio signals for display and/or storage.

One or more programmed software applications are executed by utilizing the computing resources in the DHCT 16. Note that an application typically, though not necessarily, includes a client part and a server counterpart that cooperate to provide the complete functionality of the application. The applications may be resident in memory 349, which can be volatile and/or non-volatile memory, or downloaded (or uploaded) into memory 349. Applications stored in memory 349 are executed by the processor 344 under the auspices of the operating system 353. The operating system 353 includes, among other things, at least one resource manager 367 that provides an interface to resources of the DHCT 16 such as, for example, computing resources. The operating system 353 also includes a broadcast file system (BFS) client 343 that cooperates with a BFS server (not shown) to receive data and/or applications that are delivered from the BFS server in a carousel fashion. The operating system 353 further includes device drivers, such as device driver 311, which works in cooperation with the operating system 353 to provide operating instructions for communicating with peripheral devices, such as a remote control device, or internal components, such as an integrated storage device (not shown). Data required as input by an application is stored in memory 349 and read by the processor 344 as need be during the course of application execution. Input data may be data stored in memory 349 by a secondary application or other source, either internal or external to the DHCT 16, or possibly anticipated by the application and thus created with the application at the time it was generated as a software application. Data generated by an application is stored in memory 349 by the processor 344 during the course of application execution. Memory 349 also includes application memory 370 that various applications may use for storing and/or retrieving data.

An application referred to as a navigator 355 is also resident in memory 349 for providing a navigation framework for services provided by the DHCT 16. The navigator 355 registers for and in some cases reserves certain user inputs related to navigational keys such as channel increment/decrement, Last channel, Favorite channel, etc. For example, the navigator 355 preferably includes a navigator data structure 397 (i.e., structured data such as a database or data structure) comprising a list of identifications, such as surfed channel numbers. For example, the navigator data structure 397 can be configured as a linked list of surfed channel numbers, or in other embodiments where bi-directional recall is desired, a dual-linked list. The list preferably includes a defined number of surfed channel numbers corresponding to surfed channels that can be recalled by the user pressing the Last channel button on the remote control device 480. The number of surfed channels to recall can be configured by a user, as described below. Preferably, the number of surfed channels to recall will default to a defined number, for example two. In other embodiments, the navigator data structure can be configured to store pointers to surfed channels, wherein the surfed channels are among other channels stored in a data structure located internally to the DHCT 16 or elsewhere. Some embodiments can store other identifications such as service identifiers. The navigator 355 also provides users with television related menu options that correspond to DHCT functions such as, for example, blocking a channel or a group of channels from being displayed in a channel menu presented on a screen display.

Memory 349 also includes a platform library 356. The platform library 356 is a collection of utilities useful to applications, such as a timer manager, a compression manager, a configuration manager, a hyper text markup language (HTML) parser, a database manager, a widget toolkit, a string manager, and other utilities (not shown). These utilities are accessed by applications via application programming interfaces (APIs) as necessary so that each application does not have to contain these utilities. Two components of the platform library 356 that are shown in FIG. 3 are a window manager 359 and a service application manager (SAM) client 357.

The window manager 359 includes a mechanism for implementing the sharing of the screen regions and user input. The window manager 359 is a component that, in one embodiment, is part of the platform 356, but in other embodiments may be part of the operating system 353. The window manager 359 on the DHCT 16 is responsible for, as directed by one or more applications, implementing the creation, display, and de-allocation of the limited DHCT screen resources. It allows multiple applications to share the screen by assigning ownership of screen regions, or windows. The window manager 359 communicates with the resource manager 367 to coordinate available resources (such as display memory) among different resource consuming processes. Such processes may be directly or indirectly invoked by one or more applications.

The SAM client 357 is a client component of a client-server pair of components, with the server component (not shown) being located on the headend 11, preferably in the DNCS 223 (FIG. 2). A SAM database 360 in memory 349 includes a data structure of services and a data structure of channels that are created and updated by the headend 11. Herein, database will refer to a database, structured data or other data structures as is well known to those of ordinary skill in the art. Applications can also be downloaded into memory 349 at the request of the SAM client 357, typically in response to a request by the user or in response to a message from the headend 11. In the example DHCT 16 illustrated in FIG. 3, memory 349 includes a media-on-demand (MOD) application 363, an e-mail application 365, a web browser application 366, an IPG application 394, a WatchTV application 362, and a Pay Per View (PPV) application 364 to provide the corresponding services. It should be clear to one with ordinary skill in the art that these applications are not limiting and merely serve as examples for embodiments of the invention. These applications, and others provided by the subscriber television system operator, are top-level software entities on the network for providing services to the user.

An executable program or algorithm corresponding to an operating system (OS) component, or to a client platform component, or to an application, or to respective parts thereof, can reside in and execute out of memory 349. Likewise, data input into or output from any executable program can reside in memory 349. Furthermore, an executable program or algorithm corresponding to an operating system component, or to a client platform component, or to an application, or to respective parts thereof, can reside in memory 349, or in a local storage device (not shown) externally connected to or integrated into the DHCT 16 and be transferred into memory 349 for execution. Likewise, data input for an executable program can reside in memory 349 or a storage device and be transferred into memory 349 for use by an executable program or algorithm. In addition, data output by an executable program can be written into one portion of memory 349 by an executable program or algorithm and be transferred into another portion of memory 349 or into a storage device. In other embodiments, the executable code is not transferred, but instead, functionality is effected by other mechanisms.

The DHCT 16 can also include one or more wireless or wired interfaces, also called communication ports 374, for receiving and/or transmitting data to other devices. For instance, the DHCT 16 may feature USB (Universal Serial Bus), Ethernet (for connection to a computer), IEEE-1394 (for connection to content devices in an entertainment center), serial, and/or parallel ports, among others.

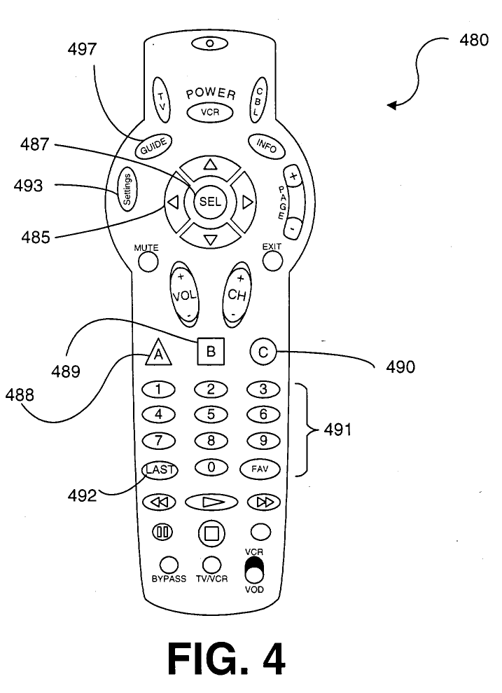

An example remote control device 480 to provide input to the DHCT 16 is illustrated in FIG. 4. The example remote control device 480 includes a select button 487 for making selections on a screen display, navigation buttons 485 for navigating within a particular screen display, and a Last channel button 492 to scroll through surfed channels, in accordance with one embodiment of the invention. In other embodiments, two last channel buttons can be used to provide recall in a positive direction (e.g., ascending channel number recall) and a negative direction (e.g., descending channel number recall). The example remote control device 480 also includes alphanumeric buttons 491 for entering display channel numbers. The “A” 488, “B” 489, and “C” 490 buttons can correspond to certain application-defined functions that have a corresponding “A”, “B”, or “C” symbol displayed in a graphic user interface (GUI) presented on a display device. The guide button 497 may be used to access a television program guide such as, for example, an IPG screen. The settings button 493 enables a user to access user settings. Many alternative methods of providing user input may be used including a remote control device with different buttons and/or button layouts, a keyboard device, a voice activated device, etc. The embodiments of the invention described herein are not limited by the type of device used to provide user input.

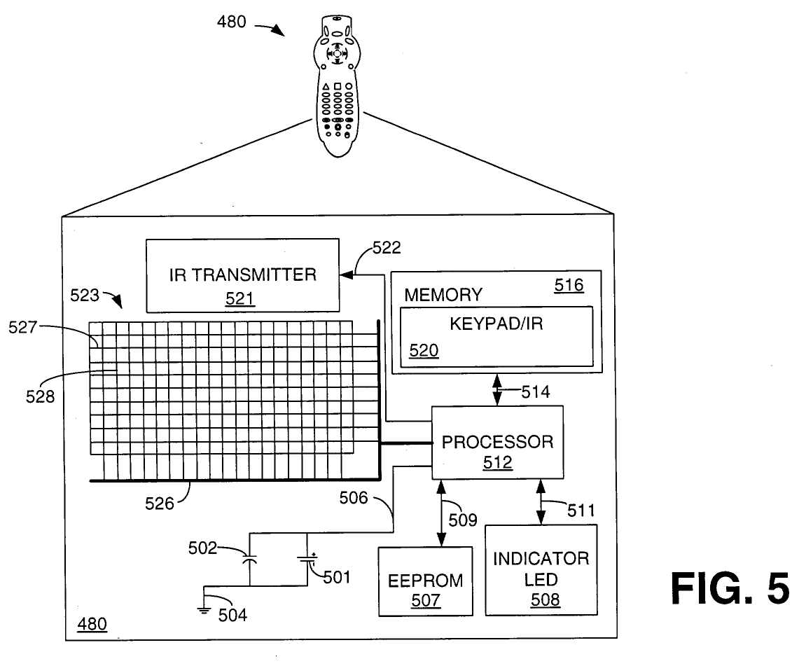

FIG. 5 is a schematic diagram of selected elements of the example remote control device 480 of FIG. 4 with, for example, infrared (IR) communication capabilities. Although an example remote control device 480 with IR functionality is shown, it will be understood that other forms of communication functionality are within the scope of the present invention, including but not limited to audio communication. The remote control device 480 includes a keypad matrix 523, which includes horizontal lines, an exemplary one of which is indicated by reference numeral 527, and vertical lines, an exemplary one of which is illustrated by reference numeral 528.

Typically, buttons on the remote control 480 are located at the intersection of horizontal lines 527 and vertical lines 528. When actuated, i.e., pressed, the button associated with the intersection of horizontal lines 527 and vertical lines 528 within the keypad matrix 523 causes an electrical connection to be made at the intersecting lines. In this manner, when a button on the remote control device 480 is pressed, a circuit is completed at the particular intersection of vertical and horizontal lines corresponding to the pressed button and a signal is sent via a communication bus 526 to a processor 512. The processor 512 analyzes the received signal and, depending upon which horizontal line and which vertical line are indicated by the button press, determines which function or key has been pressed.

The remote control device 480 also includes a power source 501, which is typically a replaceable battery, and a bypass capacitor 502. The power source 501 and the bypass capacitor 502 are grounded at location 504 and communicate via connection 506 with the processor 512. The processor 512 is also connected via connection 511 to an indicator light emitting diode (LED) 508. The indicator LED 508 indicates when an IR signal is being transmitted and also functions as a low battery indicator.

The processor 512 is also connected via connection 509 to electrically erasable programmable read only memory (EEPROM) 507. EEPROM 507 includes the remote control device 480 functions in a non-volatile memory arrangement so that when the battery in the remote control device 480 is replaced, the remote control device 480 does not lose information stored in its memory. The processor 512 communicates via connection 514 with memory 516. Memory 516 is typically a random access memory (RAM) that includes a keypad IR module 520. When the processor 512 detects a keypress from the keypad matrix 523, the processor 512 accesses memory 516 and the keypad IR module 520 to determine which IR code corresponds to the detected keypress. Once the processor 512 determines the correct IR code based on the detected keypress, the processor 512 communicates with an IR transmitter 521 via connection 522 to emit an appropriate IR signal that includes the appropriate key code to an IR receiver.

With reference to FIGS. 3 and 4, and continued reference to FIG. 5, the remote control device 480 transmits an IR signal, which is received in the DHCT 16 by the receiver 346. Although illustrated as being transmitted to the DHCT 16, the IR signal transmitted by the remote control device 480 can be received by any communication box such as the DHCT 16, directly by the television 341, or other peripheral devices. The receiver 346 demodulates the received IR signal, and preferably stores it in a temporary memory, preferably a first-in-first-out (FIFO) memory residing in the receiver 346, and then notifies the processor 344. The notification may be effected by an interrupt generated directly or indirectly by the receiver 346 or by the processor 344 polling the status of registers in the receiver 346 on a regular or periodic basis.

The driver 311 that is preferably part of the operating system 353 executes on the processor 344 to attend keypresses and releases from the remote control device 480, and fulfills the aforementioned functionality in communication with the receiver 346. A sequence of one or more demodulated IR signals corresponding to keypresses and/or releases are transferred to memory 349. Each keypress or release is converted by the operating system 353 in cooperation with the driver 311 to a keypress indication that the modules of the operating system 353, including the window manager 359 and other applications, understand. In an alternate embodiment, the receiver 346 performs the conversion to keypress indications prior to storing in its temporary FIFO memory. After the IR code has been stored (and converted to a keypress indication), the window manager 359 causes the processor 344 to generate an interrupt, which informs the navigator 355 that an IR keypress signal has been received as, explained above. The navigator 355 then retrieves the register value from memory 349 and performs the required action corresponding to the received IR keypress signal.

With reference to FIG. 3, and as with other user interface screen display examples discussed below, the processor 344 executes program instructions of the active application that cause it to employ the services of the window manager 359 to create a graphics user interface (GUI) screen display via display data that is formatted for television 341. The processor 344 stores the display data or parts thereof in memory 349 (as necessary) and transfers the display data to a display output system such as output system 348 wherein display data is converted to respective television signals and transmitted to the television set 341. Of course, the scope of the preferred embodiments of the present invention also includes other methods of causing the described user interface screen displays to appear to the user.

The preferred embodiments of the invention include a system and method that enables a user to configure the amount of surfed channels that can be recalled using the Last channel button 492 (FIG. 4). For example, the user can configure the amount of channels to recall at four. Assume the user surfs the following channels in the given order for an arbitrary length of time per channel: Channels 2, 3, 4, 25 and 26. Then while currently tuned to Channel 26, assume the user presses the Last channel button 492 on the remote control device. In response, the screen display is tuned to Channel 25. If the user presses the Last channel button 492 again, the display is tuned to Channel 4. Again, upon the user pressing the Last channel button 492, the screen display is tuned to Channel 3. If the user presses the Last channel button 492 again, the screen display is tuned to Channel 26, since the user configured the Last channel functionality to recall the last four channels he or she tuned to: 26, 25, 4, and 3. As described, the user scrolls to the surfed channels (and thus skips channels that have not been surfed) by repeatedly pressing the Last channel button 492. A similar scrolling effect can occur while in an IPG screen (not shown). That is, after the user tuned to the above mentioned channels, assume the user invokes an IPG screen (e.g., causes its display on a display screen) while watching the content instance presentation on Channel 26 (the last surfed channel as described above). By selecting the Last channel button 492, the user scrolls to the current program entry for Channel 25 in the IPG screen. Pressing the Last channel button 492 again, the user scrolls to the current program entry for Channel 4 in the IPG screen, and so on.

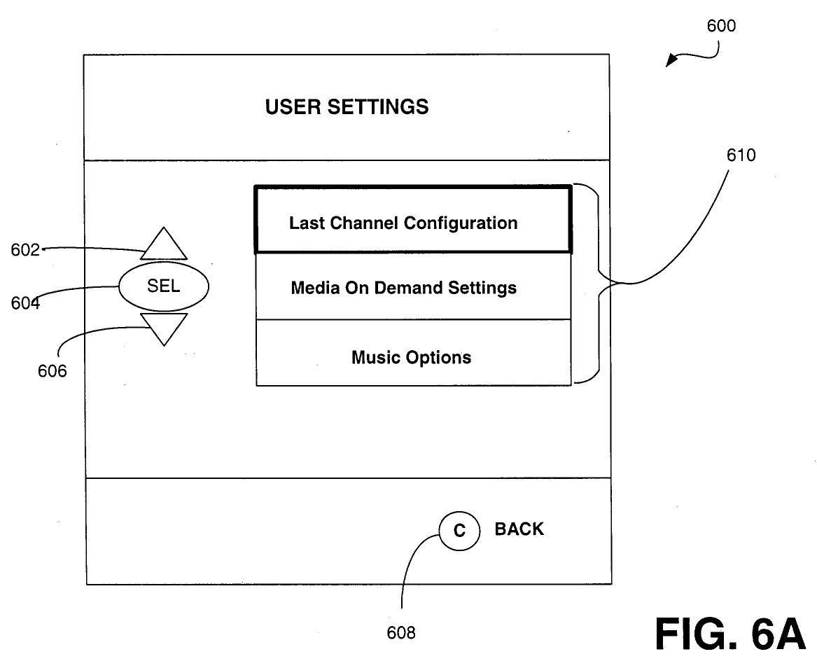

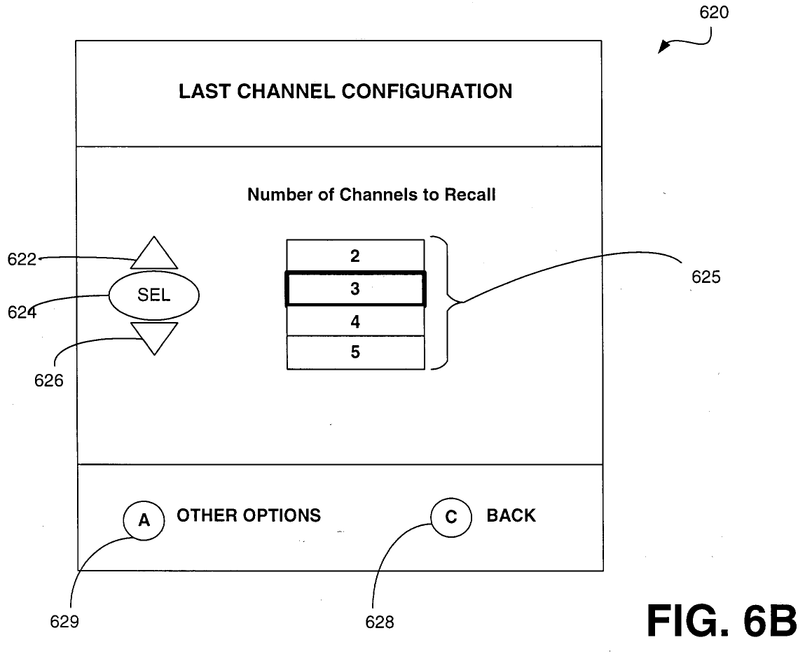

FIG. 6A is a screen diagram of an example user settings screen 600 that enables a user to configure the number of surfed channels recalled when using the Last channel button 492 (FIG. 4) on the remote control device 480 (FIG. 4). The user can invoke this screen by pressing the settings button 493 (FIG. 4) on the remote control device 480, or by pressing other buttons on the remote control device 480 as directed or suggested by a displayed icon on a screen. As shown, the user settings screen 600 includes an options list 610 that provides user setting options for a user to choose from, a select button icon 604 to make a selection from the options list 610, navigation arrow icons 602 and 606 to enable a user to scroll through the options list 610, and a “back” button icon 608 to enable the user to return to the prior screen. It will be understood that user actions described as being taken on a screen will include, in one implementation, pressing buttons on the remote control device 480 that have a corresponding function to that suggested by an icon or icons presented in the screen. For example, the “back” button icon 608 has a letter “C” contained within a circle, suggesting to the user that selecting the “C” button 490 (FIG. 4) on the remote control device 480 will provide the function of returning to the prior screen. In other embodiments, the user can make selections on the screen through the use of a cursor, or touch screen, among other well-known mechanisms for making screen selections.

In response to the user selecting the “Last Channel Configuration” option in the options list 610, the user is presented with the example Last channel configuration screen 620 shown in FIG. 6B. The example Last channel configuration screen 620 includes a recall list 625 that enables the user to select the number of surfed channels to recall when using the Last channel button 492 (FIG. 4). The example Last channel configuration screen 620 also includes a select button icon 624 for making a selection in the recall list 625, navigation arrow icons 622 and 626 for scrolling through the recall list 625, a “back” button icon 628 for returning the user to the example user settings screen 600 (FIG. 6A), and a configuration options (“Other options”) button icon 629 that includes other Last channel configuration options. For example, “Other options” may include additional screens for reversing the recalled channel order, configuring or selecting a minimum threshold of viewing or tuning time before a channel is eligible for recall, configuring or selecting the recall number per user, configuring or selecting the duration (e.g., one day, one week, until the DHCT or TV is turned off, etc.) channel numbers or other identifications corresponding to recalled channels will be stored, among other options.

Assume the user desires to recall three surfed channels and thus selects “3” from the recall list 625. In response to this selection, the user can be presented with the user settings screen 600, or in other embodiments, the user can be presented the screen from which the user launched the user settings screen 600 (e.g., if the user launched the user settings screen 600 while watching the news on display channel 2, the user can be returned to whatever programming is currently being played on channel 2).

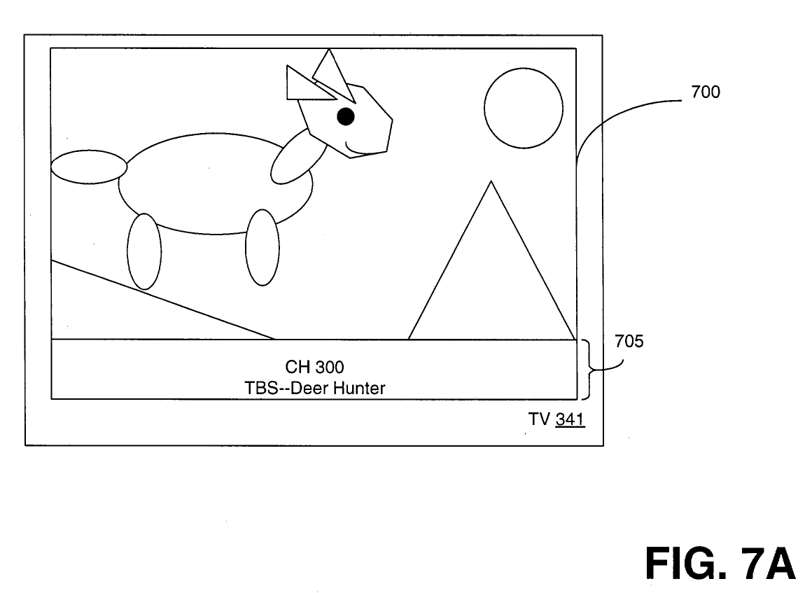

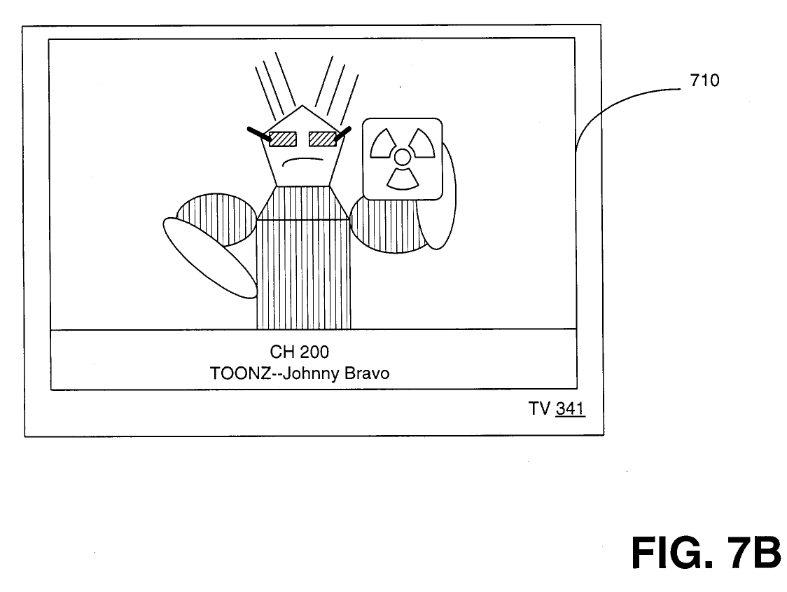

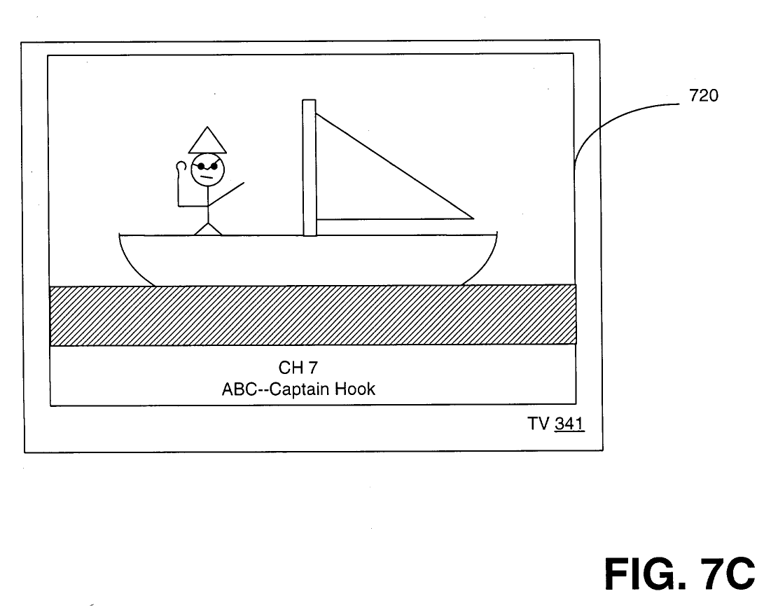

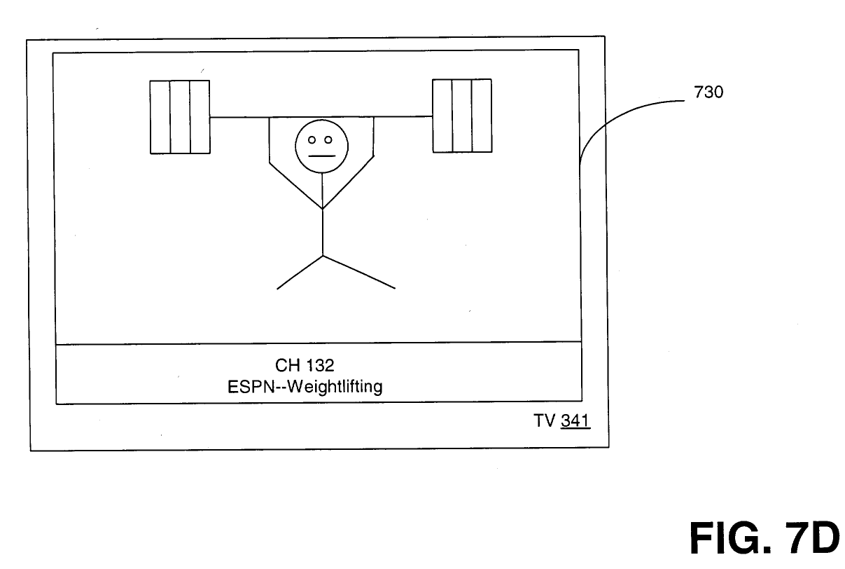

FIGS. 7A-7D are screen diagrams of some example content instance presentation screens that are presented in response to a user surfing through several programs on several display channels. These illustrations will serve as a basis for explaining Last channel functionality, in accordance with one embodiment of the invention. The user can invoke these screens from an IPG screen, or from another presentation screen, among other screens through well-known mechanisms like channel number entry, favorite channel selection, channel up or channel down buttons, among others, as would be appreciated by one having ordinary skill in the art. Assume the user was watching Deer Hunter on Channel 300 for a defined period of time as illustrated by the presentation screen 700 displayed on the television set 341 in FIG. 7A. As is true for the following presentation screens, the channel number is preferably displayed in a channel banner preferably located towards the bottom of the presentation screen, such as the example channel banner 705 shown overlaid on the presentation screen 700. One skilled in the art will appreciate that the presentation screens described below can include other elements in some embodiments, or omit elements in other embodiments. Assume then that the user surfs to Channel 200 to briefly view Johnny Bravo, as illustrated in the presentation screen 710 of FIG. 7B. As indicated above, the user could configure a minimum threshold view time for a program to be eligible for recall via pressing the Last channel button 492 (FIG. 4) on the remote control device 480 (FIG. 4), or there can be a default threshold, or no threshold at all (configured or otherwise). Subsequent to watching Johnny Bravo, the user decides to surf to Channel 7 to watch Captain Hook for a few seconds, as illustrated in the presentation screen 720 of FIG. 7C. Then, assume the user surfs to ESPN (Channel 132) to watch a weightlifting event as shown in the presentation screen 730 of FIG. 7D. Thus, the surfing channel order, starting from Channel 300, is Channel 200, Channel 7, and then Channel 132.

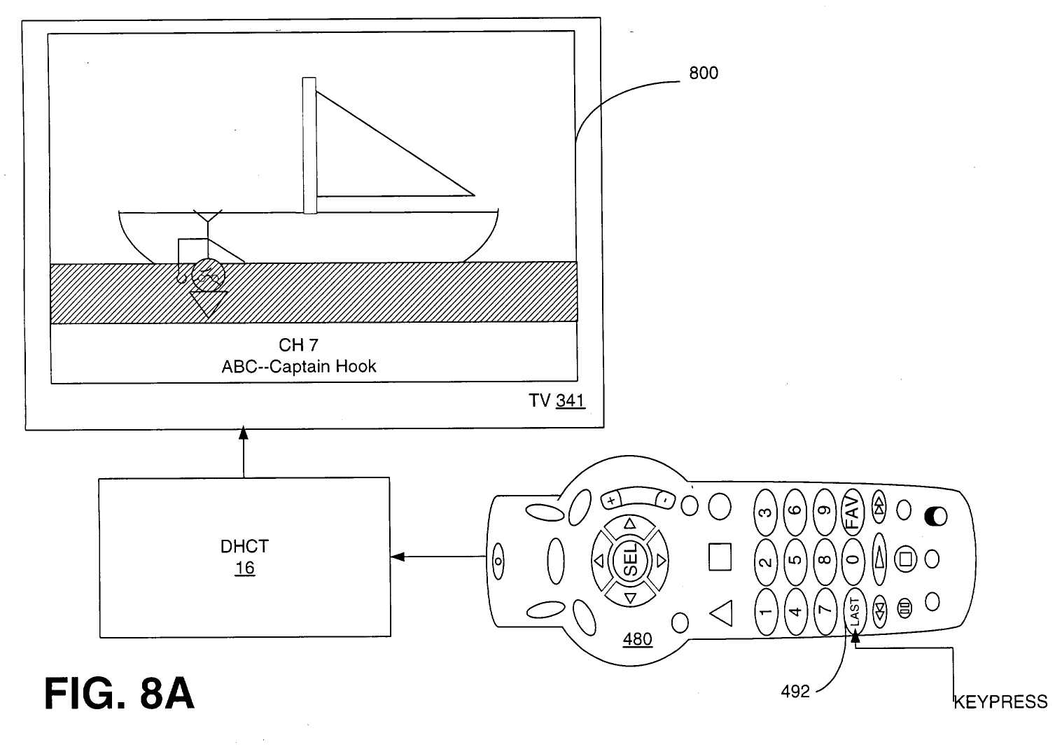

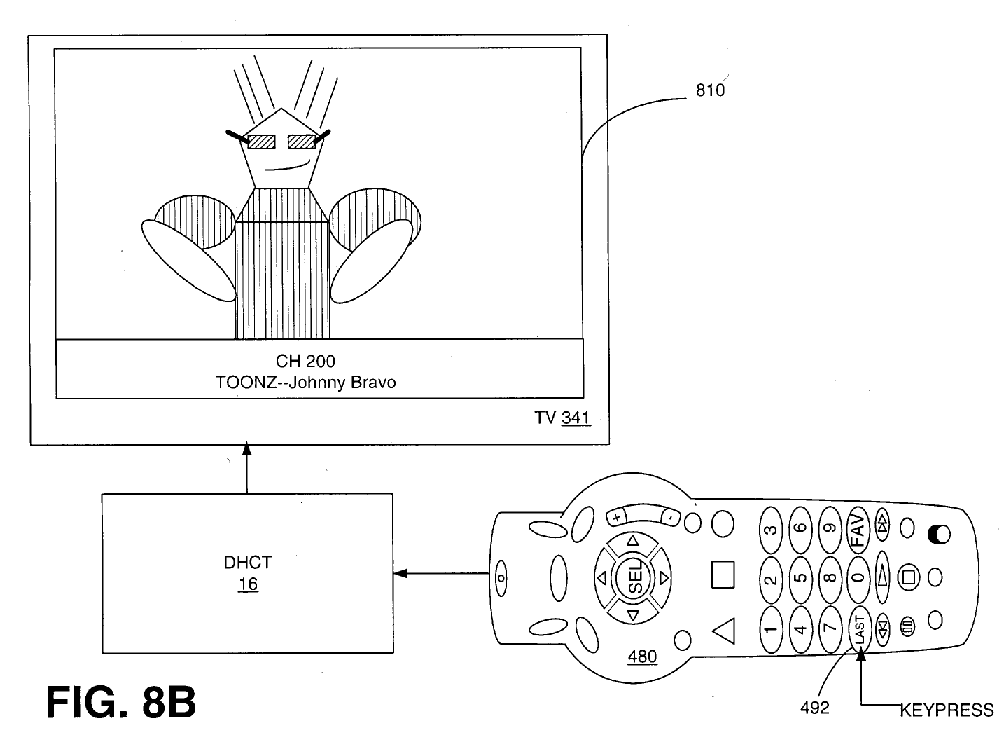

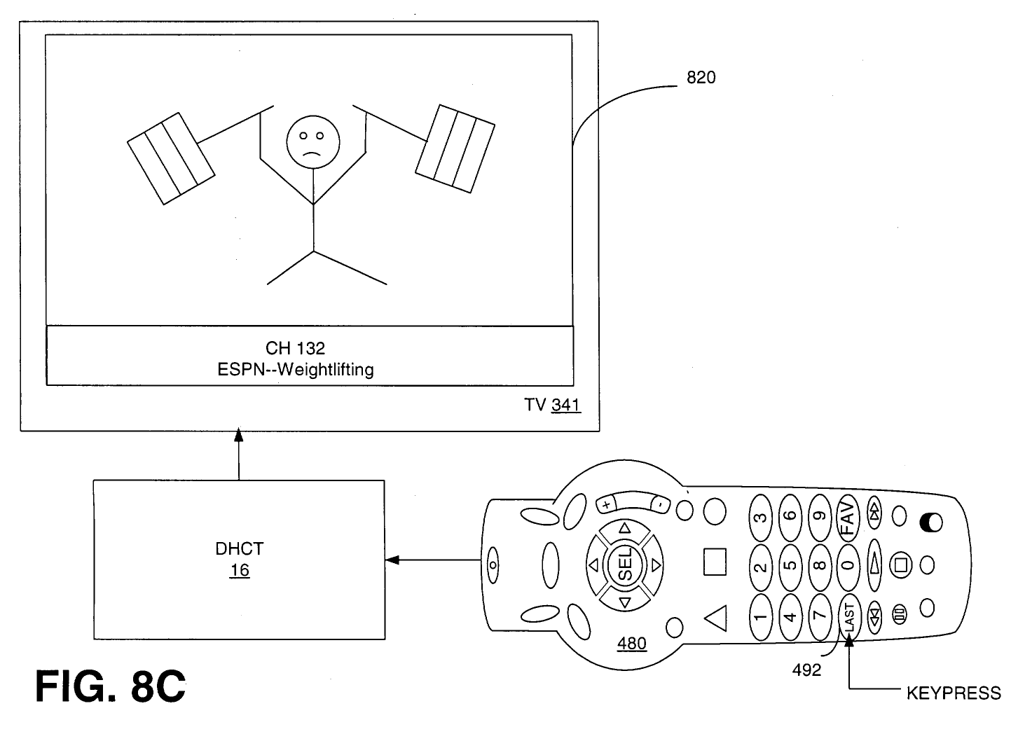

FIGS. 8A-8C are composite diagrams that illustrate one embodiment for Last channel functionality included among the preferred embodiments of the invention. Preferably, the user can recall the last three surfed channels, as configured above, by repeatedly pressing the Last channel button 492 (FIG. 4) on the remote control device 480 (FIG. 4) as the user views the content presented on each display channel. In one embodiment, the surfed channels are recalled in the reverse order (i.e., in reverse order to the surfing order). Thus, it is expected that that the recall order will be as follows: Channel 132, 7, 200, and then back to Channel 132 since three channel recall was configured. FIGS. 8A-8C include a TV set 341, a presentation screen that includes a displayed content instance corresponding to a surfed channel (with a channel banner overlaid on the content instance according to one example implementation), a DHCT 16 coupled to the TV set 341, and a remote control device 480 for providing input to the DHCT 16. Although the DHCT 16 is shown as separate from the TV set 341, in other embodiments, DHCT functionality can be integrated into the TV set 341. Further, in other embodiments, Last channel functionality can be implemented by pressing (or providing audible instruction) buttons on the TV set 341 or DHCT 16. Keypresses by a user are represented by the word, “KEYPRESS” accompanied by an arrow icon directed to the Last channel button 492.

Assume the user was watching the weightlifting event on Channel 132 (ESPN), as described in association with FIG. 7D. Then, assume the user presses the Last channel button 492, resulting in the presentation screen 800 displaying the content instance, Captain Hook, on Channel 7, as shown in FIG. 8A. As indicated above, Channel 7 was the surfed channel that was tuned to just prior to the tuning of Channel 132. Since, in one embodiment, the surfed channels are recalled in reverse order (i.e., reverse to the surfed order), the currently presented content instance (Captain Hook) on Channel 7 is displayed in response to pressing the Last channel button 492 while viewing the weightlifting event on Channel 132.

FIG. 8B is a screen diagram of an example presentation screen 810 illustrating one example response to selecting the Last channel button 492 while watching Captain Hook on Channel 7, in accordance with one embodiment of the invention. As shown, the presentation screen 810 presented is that corresponding to Johnny Bravo on Channel 200, which was the surfed channel prior to Channel 7. Continuing the example recall implementation, FIG. 8C is a screen diagram of an example presentation screen 820 resulting from the user pressing the Last channel button 492 while tuned to Channel 200. As shown, Channel 132 is responsively tuned to, which was the channel from which the user initiated the Last channel recall implementation. Since the user configured Last channel functionality to recall the last three surfed channels, the user is responsively presented with the presentation screens of the last three surfed channels (Channels 132, 7, and 200) as he or she presses the Last channel button 492. The content instances of these recalled channels will be displayed in the presentation screens in a cyclical manner as long as the user continues to press the Last channel button 492.

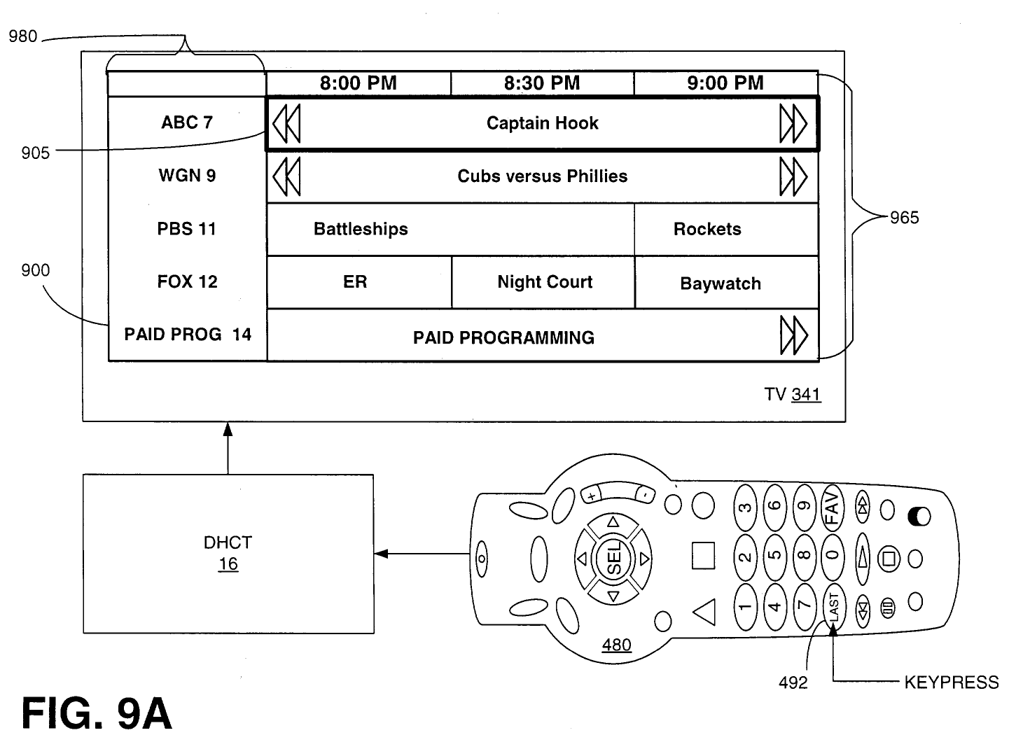

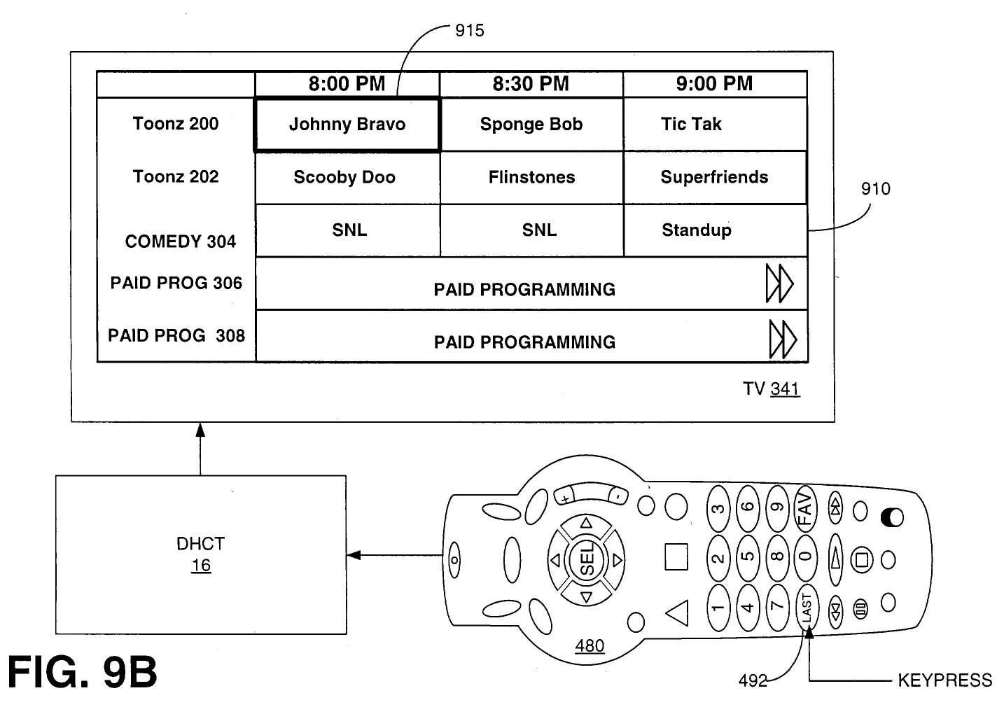

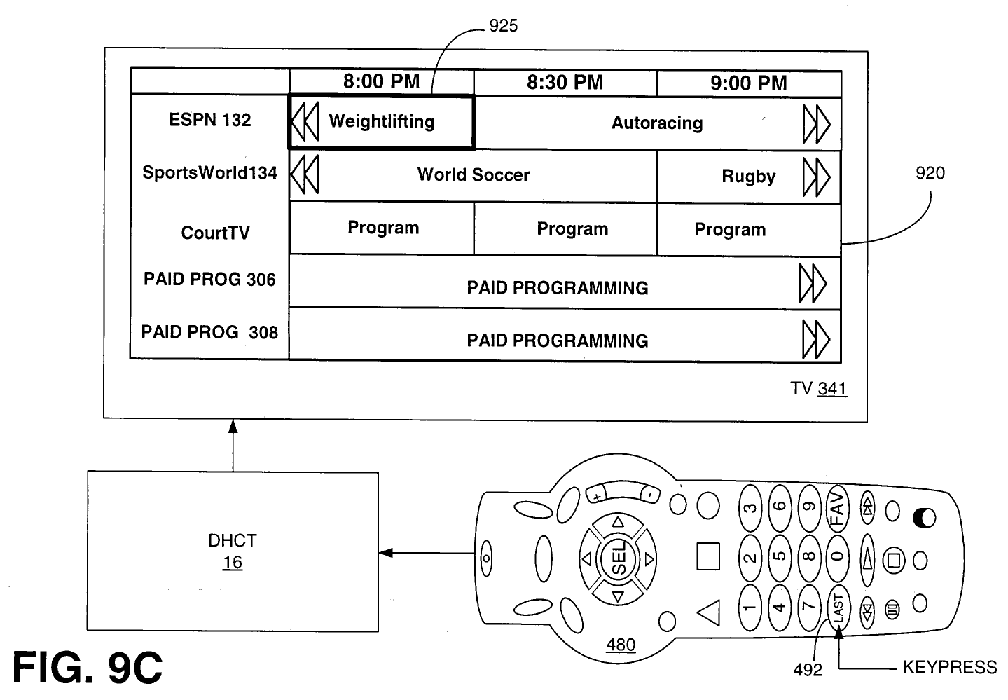

Note that if the user seeks to add more channels to recall, the user preferably returns to the Last channel configuration screen 620 (FIG. 6B) to select a greater number of recalled surfed channels. As described above, a similar mechanism to that described for the content instance presentation screens is employed when the user decides to recall surfed channels while in an IPG screen, as illustrated in the example IPG screens of FIGS. 9A-9C. FIGS. 9A-9C are composite diagrams that include an example IPG screen displayed on a TV set 341, a DHCT 16 coupled to the TV set 341, and a remote control device 480 that provides input to the DHCT 16. User keypresses are represented by the word “KEYPRESS” in association with an arrow icon that points to the Last channel button 492. For the sake of simplicity in discussion, the IPG screens of FIGS. 9A-9C are illustrated with an IPG grid and display channel area only (e.g., the IPG grid 965 and the channel area 980 of FIG. 9A). Assume the user was watching the presentation screens of FIGS. 7A-7D in the order described above (Channel 300, 200, 7, and 132), and then the user decides to invoke an IPG screen (e.g., by selecting the guide button 497 (FIG. 4) on the remote control device 480) while watching the weightlifting event on Channel 132.

In FIG. 9A, the user is presented at the current program entry for Channel 7 in the example IPG screen 900 in response to pressing the Last channel button 492 while the weightlifting program entry for Channel 132 was highlighted in a prior IPG screen (not shown). The user is preferably positioned at the current program entry for Channel 7, as indicated by the highlighted program entry 905 (entitled, Captain Hook). If the user then selects the Last channel button 492 again, the user is positioned at the highlighted program entry 915 entitled, Johnny Bravo, on Channel 200, as shown in the example IPG screen 910 of FIG. 9B. Continuing the example, if the user presses the Last channel button 492 while on Channel 200 in the example IPG screen 910, the user is positioned back to the highlighted program entry 925 entitled, “Weightlifting” on Channel 132 in the example IPG screen 920 shown in FIG. 9C. Thus, the user cycles through the three last channels as he or she presses the Last channel button 492.

In other embodiments, the surfed channels can be recalled in other orders, such as in a forward order, for example, the initial surfing order, or in some embodiments, the user can choose to recall the surfed channels in either order (e.g., through the use of a forward direction last channel button and a reverse direction last channel button, or implemented through the use of special keypress functions, such as simultaneously (or in rapid succession) pressing the select button and last channel button to provide directional functionality, or entering a mode through a series of keypresses, among other mechanisms).

In some embodiments, an IPG screen includes a portion of the screen dedicated to the display of a content instance presentation (e.g., quarter screen display of the IPG screen) corresponding to a currently selected program entry in the IPG. In such embodiments, the user may surf among program entries in the IPG screen with the corresponding display of the content instance presentation similarly changing in accordance with the selected program entry. The preferred embodiments of the invention include the ability to enable a user to recall these partially displayed surfed channels in a manner similar to mechanisms described above.

The navigator application 355 (and database 397) can be implemented in hardware, software, firmware, or a combination thereof. In the preferred embodiment(s), the navigator application 355 is implemented in software or firmware that is stored in a memory and that is executed by a suitable instruction execution system. If implemented in hardware, as in an alternative embodiment, the navigator application 355 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The navigator application 355 which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the present invention, particularly, any “preferred embodiments” are merely possible examples of implementations, merely setting forth a clear understanding of the principles of the inventions. Many variations and modifications may be made to the above-described embodiments of the invention without departing substantially from the spirit of the principles of the invention. All such modifications and variations are intended to be included herein within the scope of the disclosure and present invention and protected by the following claims.

Therefore, having thus described the invention, at least the following is claimed:

1. A method for recalling surfed channels, the method comprising the steps of:
storing identifications of surfed channels; and
recalling each of the surfed channels in response to a user pressing a button on a device.

2. The method of claim 1, wherein the step of recalling includes the step of highlighting a program entry associated with at least one of the surfed channels in an interactive programming guide screen.

3. The method of claim 1, wherein the step of recalling includes the step of tuning to a presentation screen associated with at least one of the surfed channels, wherein the presentation screen includes a display of a content instance.

4. The method of claim 1, further including the step of providing a user interface screen to enable a user to configure at least one of the surfed channels that can be recalled, the chronological order that the surfed channels can be recalled, a minimum threshold duration that a channel should be tuned to in order to be considered a surfed channel eligible for being recalled, and a duration of storing the identifications of the surfed channels.

5. The method of claim 1, wherein the button includes a Last channel button.

6. The method of claim 1, wherein the step of storing includes the step of storing the identifications in a data structure in memory.

7. The method of claim 1, wherein the steps of storing and recalling includes the steps of storing at least three identifications and recalling at least three surfed channels corresponding to the three stored identifications.

8. The method of claim 1, further including the step of recalling each of the surfed channels corresponding to the stored identifications in an opposite chronological order in response to a user pressing a second button on the device.

9. The method of claim 1, wherein the device is at least one of a remote control device, a digital home communication terminal, an analog home communication terminal, and a television set.

10. The method of claim 1, wherein a number of identifications to store is configurable.

11. The method of claim 1, wherein the identifications include at least one of a surfed channel number and a service identifier corresponding to at least one of the surfed channels.

12. A method for recalling surfed channels, the method comprising the steps of:
storing a pointer to a configured number of surfed channels; and
recalling each of the configured number of surfed channels in response to a user pressing a button on a remote control device.

13. The method of claim 12, wherein the step of recalling includes the step of highlighting a program entry associated with the configured number of surfed channel in an interactive programming guide screen.

14. The method of claim 12, wherein the step of recalling includes the step of tuning to a presentation screen associated with the configured number of surfed channels, wherein the presentation screen includes a display of a content instance.

15. A method for recalling surfed channels, the method comprising the steps of:
storing at least three identifications of surfed channels in a short term surfed channel list; and
recalling each of the surfed channels corresponding to the at least three identifications in response to a user pressing a button on a device.

16. The method of claim 15, wherein the step of storing includes the step of storing a user configurable number of identifications of surfed channels in a data structure in memory.

17. The method of claim 15, wherein the step of recalling includes the step of highlighting a program entry associated with at least one of the surfed channels in an interactive programming guide screen.

18. The method of claim 15, wherein the step of recalling includes the step of tuning to a presentation screen associated with at least one of the surfed channels, wherein the presentation screen includes a display of a content instance.

19. The method of claim 15, further including the step of providing a user interface screen to enable a user to configure at least one of the surfed channels that can be recalled, the chronological order that the surfed channels can be recalled, a minimum threshold duration that a channel should be tuned to in order to be considered a surfed channel eligible for being recalled, and a duration of storing the identifications of the surfed channels.

20. The method of claim 15, wherein the device is at least one of a remote control device, a digital home communication terminal, an analog home communication terminal, and a television set.

21. The method of claim 15, wherein the identifications include at least one of a surfed channel number and a service identifier corresponding to at least one of the surfed channels.

22. A method for recalling surfed channels, the method comprising the steps of:
providing a user interface screen to enable a user to configure at least one of a number of surfed channels that can be recalled, a chronological order that the surfed channels can be recalled, a minimum threshold duration that a channel should be tuned to in order to be considered a surfed channel eligible for being recalled, and a duration of storing identifications of the surfed channels;
storing the identifications of the surfed channels; and
recalling each of the surfed channels corresponding to the stored identifications in response to a user pressing a button on a remote control device.

23. A system for recalling surfed channels, the system comprising:
a memory with logic; and
a processor configured with the logic to store identifications of surfed channels, wherein the processor is further configured with the logic to recall each of the surfed channels in response to a user pressing a button on a device.

24. The system of claim 23, wherein the processor is further configured with the logic recall by highlighting a program entry associated with at least one of the surfed channels in an interactive programming guide screen.

25. The system of claim 23, wherein the processor is further configured with the logic recall by tuning to a presentation screen associated with at least one of the surfed channels, wherein the presentation screen includes a display of a content instance.

26. The system of claim 23, wherein the processor is further configured with the logic to provide a user interface screen to enable a user to configure at least one of the surfed channels that can be recalled, a chronological order that the surfed channels can be recalled, a minimum threshold duration that a channel should be tuned to in order to be considered a surfed channel eligible for being recalled, and a duration of storing the identifications of the surfed channels.

27. The system of claim 23, wherein the button includes a Last channel button.

28. The system of claim 23, wherein the processor is further configured with the logic to store the identifications in a data structure in memory.

29. The system of claim 23, wherein the processor is further configured with the logic to store at least three identifications and recall at least three surfed channels corresponding to the three stored identifications.

30. The system of claim 23, wherein the processor is further configured with the logic to recall the surfed channels corresponding to the stored identifications in an opposite chronological order in response to a user pressing a second button on the device.

31. The system of claim 23, wherein the device is at least one of a remote control device, a digital home communication terminal, an analog home communication terminal, and a television set.

32. The system of claim 23, wherein a number of identifications to store is configurable.

33. The system of claim 23, wherein the identifications include at least one of a surfed channel number and a service identifier corresponding to at least one of the surfed channels.

34. A system for recalling surfed channels, the system comprising:
a memory with logic; and
a processor configured with the logic to store a pointer to a configured number of surfed channels, wherein the processor is further configured with the logic to recall each of the configured number of surfed channels in response to a user pressing a button on a remote control device.

35. The system of claim 34, wherein the processor is further configured with the logic to recall by highlighting a program entry associated with the configured number of surfed channel in an interactive programming guide screen.

36. The system of claim 34, wherein the processor is further configured with the logic to recall by tuning to a presentation screen associated with the configured number of surfed channels, wherein the presentation screen includes a display of a content instance.

37. A system for recalling surfed channels, the system comprising:
a memory with logic; and
a processor configured with the logic to store at least three identifications of surfed channels in a short term surfed channel list, wherein the processor is further configured with the logic to recall each of the surfed channels corresponding to the stored identifications in response to a user pressing a button on a device.

38. The system of claim 37, wherein the processor is further configured with the logic store a user configurable number of identifications of surfed channels in a data structure in memory.

39. The system of claim 37, wherein the processor is further configured with the logic to recall by highlighting a program entry associated with at least one of the surfed channels corresponding to the stored identifications in an interactive programming guide screen.

40. The system of claim 37, wherein the processor is further configured with the logic to recall by tuning to a presentation screen associated with at least one of the surfed channels, wherein the presentation screen includes a display of a content instance.

41. The system of claim 37, wherein the processor is further configured with the logic to provide a user interface screen to enable a user to configure at least one of the surfed channels that can be recalled, a chronological order that the surfed channels can be recalled, a minimum threshold duration that a channel should be tuned to in order to be considered a surfed channel eligible for being recalled, and a duration of storing the identifications of the surfed channels.

42. The system of claim 37, wherein the device is at least one of a remote control device, a digital home communication terminal, an analog home communication terminal, and a television set.

43. The system of claim 37, wherein the identifications include at least one of a surfed channel number and a service identifier corresponding to at least one of the surfed channels.

44. A system for recalling surfed channels, the system comprising:
a memory with logic; and
a processor configured with the logic to provide a user interface screen to enable a user to configure at least one of a number of surfed channels that can be recalled, a chronological order that the surfed channels can be recalled, a minimum threshold duration that a channel should be tuned to in order to be considered a surfed channel eligible for being recalled, and a duration of storing identifications of the surfed channels, wherein the processor is further configured with the logic to store the identifications of the surfed channels, wherein the processor is further configured with the logic to recall each of the surfed channels corresponding to the stored identifications in response to a user pressing a button on a remote control device.
